(19) United States
(12) Patent Application Publication
(10) Pub. No.: US 2010/0177165 A1
(43) Pub. Date: Jul. 15, 2010

(54) METHOD OF CONDUCTING PRECONDITIONED RELIABILITY TEST OF SEMICONDUCTOR PACKAGE USING CONVECTION AND 3-D IMAGING

(75) Inventors: Hye-Kyong Oh, Hwasung-City (KR); Ho-Jeong Moon, Hwasung-City (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/686,496

(22) Filed: Jan. 13, 2010

(30) Foreign Application Priority Data
Jan. 13, 2009 (KR) 10-2009-0002681

(51) Int. Cl. H04N 13/02; G01N 25/00

(52) U.S. Cl. 348/46; 374/57; 348/E13.074

(57) ABSTRACT

A precondition reliability test of a semiconductor package, to determine a propensity of the package to delaminate, includes a baking test of drying the package, a moisture soaking test of moisturizing the dried package, a reflow test of heat-treating the moisturized package using hot air convection, and a three-dimensional imaging of the package to acquire a 3-D image of a surface of the package. The three-dimensional imaging is preferably carried out using a Moire interferometry technique during the course of the reflow test. Therefore, the delamination of the package can be observed in real time so that data on the start and rapid development of the delamination can be produced. The method also allows data which can be ordered as a Weibull Plot to be produced, thereby enabling a quantitative analysis of the reliability test results.

### CROSS-REFERENCE TO RELATED APPLICATIONS

This application claims the benefit of priority under 35 U.S.C. §119 from Korean Patent Application No. 10-2009-0002681, filed on Jan. 13, 2009.

### BACKGROUND

The inventive concept relates to the testing of the reliability of semiconductor packages. More particularly, the inventive concept relates to a method of determining tendencies of a semiconductor chip or an encapsulant of a semiconductor package to delaminate from a substrate of the package under various reflow conditions that exist when, for example, the package is mounted on a board.

A conventional semiconductor package includes a semiconductor chip and a lead frame integrated with the chip. The lead frame includes a die pad, inner leads, and outer leads. The semiconductor chip is mounted on the die pad by an adhesive, and the semiconductor chip is bonded and hence, electrically connected, to the inner leads of the lead frame by bonding wires. In addition, the chip and the bonding wires may be encapsulated by a molding compound, e.g., a resin, to protect the chip. The outer leads function to electrically connect the semiconductor chip to circuitry outside the package.

The semiconductor package is mounted to a printed circuit board (PCB), for example, by soldering the outer leads of the package to the circuitry printed on the substrate of the PCB. During the time it takes to mount the package to the printed circuit board, the package is absorbing moisture in the atmosphere. The soldering of the package to the PCB is performed at a high temperature of about 240° C. to cause the solder to reflow. Thus, if the moisture content of the package is too great, the package could be broken or delaminated (separation of the chip or molding compound from the lead frame) by the reflow process. Therefore, the likelihood of the package cracking or delaminating must be checked before the package is mounted on the PCB. Such a test, performed on the completed package before the package is mounted, is referred to as a precondition test.

### SUMMARY

A method of testing the reliability of a semiconductor package includes baking the package to dry the package, moisturizing the dried package, performing a reflow test on the moisturized package by heating air and circulating the heated air across a surface of the moisturized package such that the moisturized package is heated by convection, and performing a 3-D imaging of the package in which a three-dimensional image of the surface of the sample is acquired at a time after the reflow test has been initiated. Using a combination of convection and 3-D imaging allows the delaminating of the package to be determined in real time.

### BRIEF DESCRIPTION OF THE DRAWINGS

Preferred embodiments of the inventive concept will be described in further detail below with reference to the accompanying drawings. In the drawings:

FIG. 1 is a flowchart of a precondition test method;

FIG. 2 is a representative diagram of images of sample packages, showing the delamination of some of the packages, obtained using the test method of FIG. 1;

FIG. 3 is a flowchart of an embodiment of a precondition test method in accordance with the inventive concept;

FIG. 4 is a schematic diagram of an example of equipment that can be used to carry out a precondition test method in accordance with the inventive concept;

FIG. 5 is a representative diagram of images of sample packages, showing the delamination of some of the packages, obtained using an embodiment of the inventive concept which employs a Moire technique;

FIG. 6 is a representative diagram of images, showing the starting point and development of delamination of a package, which can be obtained in accordance with the inventive concept; and

FIG. 7 is a graph of test results, which can be obtained in accordance with the inventive concept, the graph using a Weibull Plot to show the relationship between critical temperature and accumulated failure rate.

### DETAILED DESCRIPTION OF THE PREFERRED EMBODIMENTS

As described in the background, a semiconductor chip may be mounted on a substrate, such a lead frame, by a die-bonding process in which the chip is secured to a die pad of the substrate by an adhesive. In addition, a molding process is performed to encapsulate and thereby protect the semiconductor chip. In these cases, the semiconductor chip or encapsulant may be delaminated from the substrate when the package is soldered to a printed circuit board, i.e., when the temperature is raised above the melting point of the solder to 30° C. or more. At this temperature, moisture in the package expands several to several hundreds of times. The expansion of the moisture may cause a popcorn or delamination phenomenon to occur at an interface between the substrate and the semiconductor chip or between the substrate and the encapsulant.

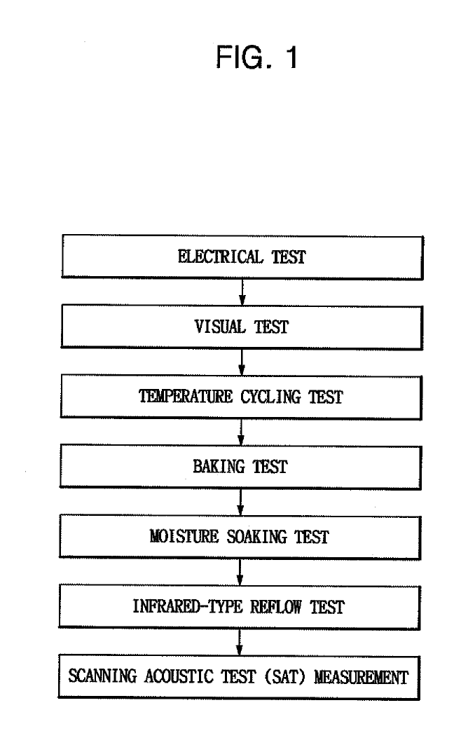

Therefore, a precondition test, as part of the reliability testing of the semiconductor package, is performed to measure predictors of such phenomena. As shown in FIG. 1, the precondition test includes an electrical test, a visual test, a temperature cycling test, a baking test, a moisture soaking test, a reflow test, and a scanning acoustic tomography (SAT) measurement. The electrical and visual tests may be conventional, i.e., known in the art per se, and therefore will not be described in any detail.

The temperature cycling test entails heating the semiconductor package through a range of temperatures a number of times (cycles). For example, the temperature cycling test heats the package through a temperature range of from −55° C. to 125° C. over five cycles. The temperature cycling test is performed before the baking test, the moisture soaking test, and the reflow test.

The baking test functions to dry the package at a high temperature. In an example of the baking test, the package is stored at a temperature of 125° C. for 24 hours.

The moisture soaking test moisturizes the dried package. The moisture soaking test is performed to check the level of moisture that the semiconductor package will absorb while the package is stored on the line along which it is conveyed prior to being mounted to the board. The moisture soaking test may be carried out selectively at one of various levels simulating environmental conditions during the manufacturing process between the time a semiconductor package is fabricated and the time the package is mounted to a board or the like. For example, the moisture soaking test may be selectively performed at a first condition (Level 1) in which the package is exposed to a temperature and relative humidity of 85° C./85% RH for 168 hours or less, a second condition (Level 2) of 85° C./65% RH for 168 hours or less, and a third condition (Level 3) of 30° C./60% RH for 192 hours or less. The third condition is representative of conditions between the time a vacuum-sealed type of package in which the semiconductor package has been placed is opened and the time the semiconductor package is removed therefrom and mounted on a board.

The reflow test heats the package to a high temperature so as to simulate the case of a reflow process, e.g., the soldering of the package to a PCB or the like. In the precondition test shown in FIG. 1, the reflow test is performed by exposing the package to infrared radiation (light emitted form an infrared source). The reflow test reveals a thermal history of the package and, in particular, reveals characteristics of a package that has absorbed moisture under given environmental conditions and has then been exposed to a high temperature.

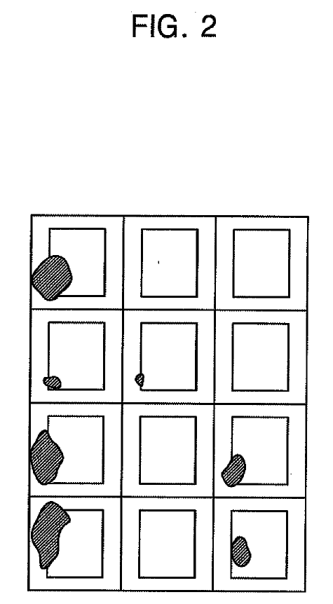

After the reflow test, the thermal history is inspected through scanning acoustic tomography (referred to hereinafter as SAT). FIG. 2 shows delamination occurring in several samples as a result of the reflow test.

In this precondition test, the failure rate is determined through SAT measurement. Therefore, the point at which the delamination (FIG. 2) begins to occur cannot be determined, and the state of the delamination also cannot be accurately determined. In addition, a large number of samples, e.g., at least 480 samples, must be tested if any meaningful results are to be obtained. In particular, it is difficult to quantitatively and statistically analyze the results of the precondition test shown in FIG. 1 because the precondition test merely determines the number of failures. Therefore, it is difficult to provide a good reliability expectation analysis and estimation from the precondition test.

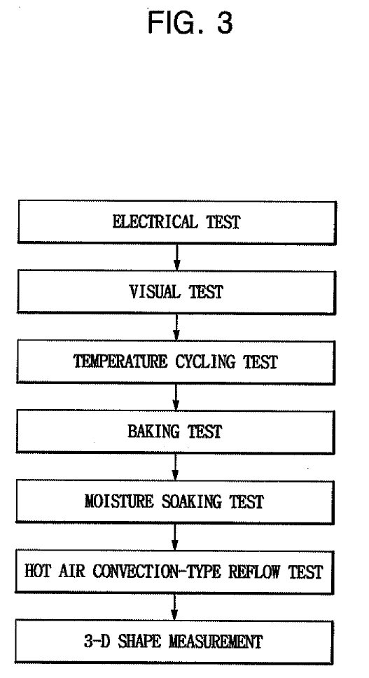

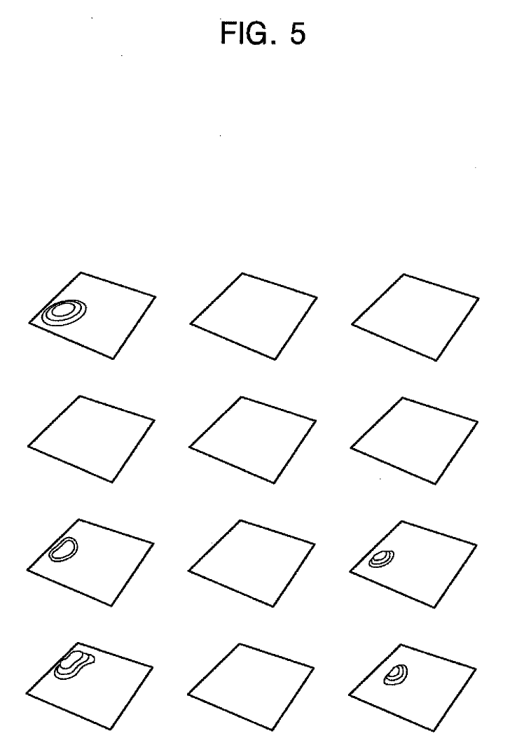

Examples of the inventive concept will now be described more fully with reference to FIGS. 3-7.

In one embodiment of the inventive concept, as shown in FIG. 3, the precondition test is similar to that shown in FIG. 1 as concerns the basic processes up to the drying and moisturizing of the package. Therefore, these processes will not be described in further detail. However, unlike the test method shown in and described with respect to FIG. 1, the simulation of the reflow process is performed using convection, and the thermal history, i.e., the state of delamination, is checked using a 3-D shape measurement method. The reflow test and the 3-D shape measurement method will now be described in detail.

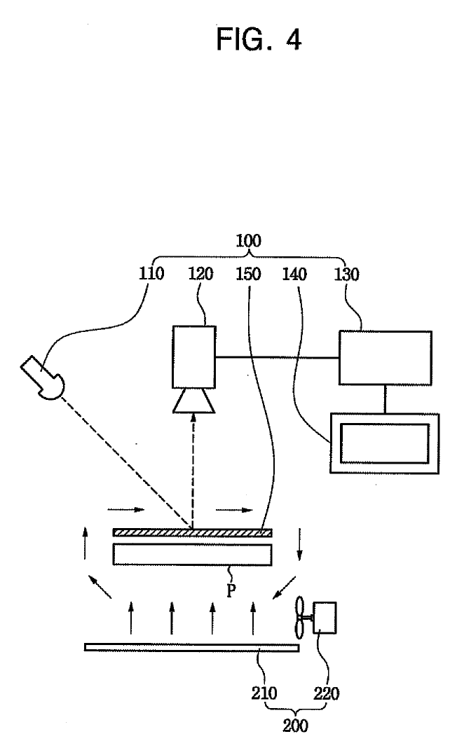

The reflow test comprises circulating hot air over the package (sample). To this end, a heat source 200 (FIG. 4) that performs the reflow test on the sample may comprise a hot air convection oven, and more particularly, comprises a heater 210 for heating air and a convection fan 220 for circulating the hot air over the package (sample). Although infrared (IR) heating, as used in the method of FIG. 1, may be advantageous in terms of the relatively rapid rate at which the sample can be heated, an IR heat source produces a shadow over part of the sample making it impossible to provide a desired uniformity in the reflow test. On the other hand, the hot air convection method can forcedly circulate hot air to all corners of the package such that the reflow test can be performed uniformly across the sample.

The three-dimensional (3-D) shape measurement method is used to check the thermal history of the sample that has been moisturized and heated using convection. In an embodiment of the inventive concept, the optical 3-D shape measurement method uses Moire Interference Fringes so that the 3-D shape measurement method is a non-contact method, can be performed at a high speed, and produces highly precise results. Such a 3-D shape measurement method basically comprises illuminating a surface of the sample with the light of a given shape, producing Moire Interference Fringes from the light, and measuring and analyzing Moire Fringes of light that has reflected from the surface of the sample. It is possible to obtain a 3-D image of the surface of the sample using such a Moire interferometry method, and, if necessary, a color image thereof.

Moire methods have a wide range of testing and analysis applications including in two-dimensional and 3-D imaging. Moire interferometry methods include Shadow Moire and Projection Moire, classifications based on the method of forming the Moire Fringes. Shadow Moire is a method in which a surface of an object being analyzed is irradiated without using a lens. Projection Moire is a method in which a surface is irradiated with light projected onto the surface using a lens. As pertains to the present embodiment, Shadow Moire is preferable because it requires less equipment than Projection Moire, and allows a grating and the sample to be positioned close to each other.

An example of equipment for performing the Moire interferometry method in an embodiment of a precondition test according to the inventive concept will now be described in detail with reference again to FIG. 4. The equipment 100 for obtaining a 3-D image includes a light projector 110 comprising a light source for irradiating a sample, a camera unit 120 that captures images of the sample, a computer 130 configured to process the image, a monitor 140 to display the image, and a grating 150 configured to produce Moire Interference Fringes. The light projector 110 may employ a laser as a light source, or may employ a color projector. The camera unit 120 may employ one or more cameras such as CCD camera, a CMOS camera, a digital camera, or the like. The computer 130 may be a desk-top computer or a notebook computer. Also, the computer 130 may include a controller configured to control the acquisition of an image of the sample by the camera unit 120, and a processor configured to convert the image captured by the camera unit 120 into data representative of a 3-D image, i.e., the contour, of the surface of the sample. The monitor 140 functions to display the image obtained by the camera unit 120 and processed by the computer 130. The equipment 100 shown in FIG. 4 is an example only and does not limit the precondition test according to the inventive concept. That is, other set-ups/equipment can be used to perform the reflow test using convection, and acquire a 3-D image of the surface of the sample.

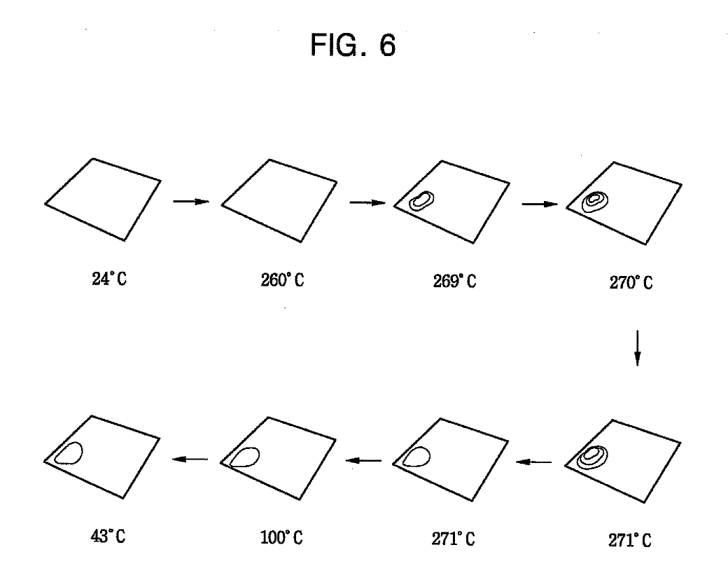

When the hot air convection reflow test and the 3-D shape measurement are employed in the precondition test according to the inventive concept, the point at which the semiconductor package will start to delaminate (a so-called “delamination start point”) can be precisely determined. As shown in FIG. 6, the images obtained in an example of a precondition test carried out according to the inventive concept reveal a delamination start point of 269° C. In addition, the images reveal that that the delamination has progressed remarkably at a temperature of 271° C.

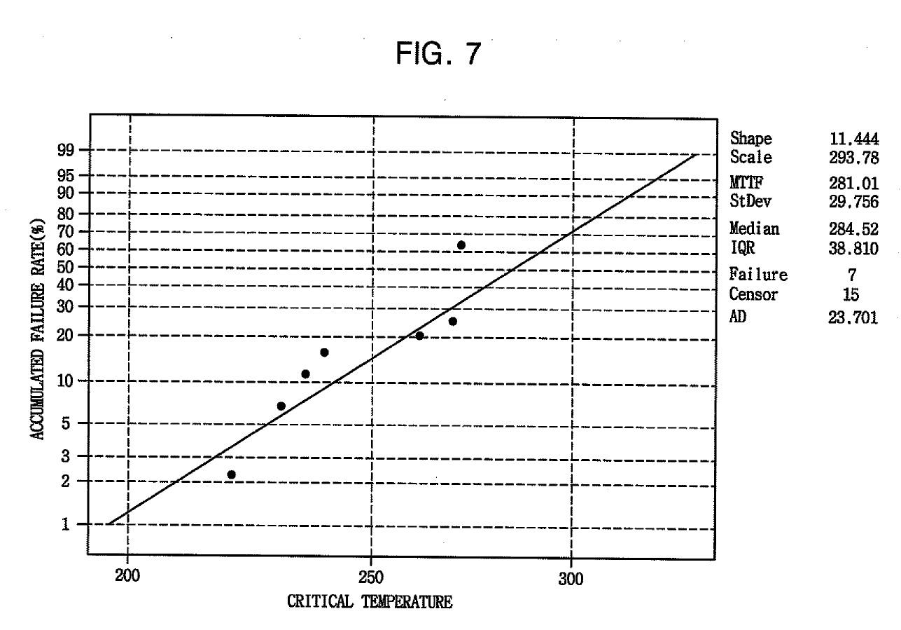

FIG. 7 shows that data obtained using a method according to the inventive concept can be ordered as a Weibull Plot to show the relationship between the critical temperature and the accumulated failure rate. The data shown in FIG. 7 was obtained by performing a baking test of drying samples at 125° C. for 24 hours, performing a moisture soaking test of moisturizing the samples by exposing the samples to ambient air of 30° C./60% RH for 192 hours, performing a reflow test of heating the samples 1 or 3 cycles through a range of temperatures including a temperature of at least 260° C. using hot air convection, and analyzing the results of the 3-D shape measurement in which 3-D images of each of the samples were acquired at each interval of 1° C. as the temperature of the sample was increased during the reflow test.

Such a Weibull Plot as shown in FIG. 7 allows the critical conditions and in particular, the temperature at which delamination starts (delamination start point) and the temperature at which the delamination becomes maximum (delamination development state), to be precisely estimated. Just as importantly, though, the delamination start point and delamination development state can be determined in real time.

More specifically, the SAT measurement as employed in the method shown in FIG. 1 can only examine the state of delamination of a package after the reflow test has been performed. Furthermore, the temperature of the reflow test may also be increased only in increments of 15° C. between SAT measurements. On the other hand, the Moire 3-D imaging as employed in the embodiment of FIG. 7 may be carried out during the reflow test, i.e., in real time. Furthermore, hot air convection of forcedly circulating heat around the package can be controlled to increase the temperature of the reflow test by increments of 1° C. beginning at temperatures as low as room temperature. Thus, the reflow test can be optimized. Also, the 3-D shape measurement test can be performed at each of different temperatures which vary only slightly from each other such as by increments of 1° C. Thus the precondition test according to the inventive concept can produces data appropriate for quantitative statistical analysis. For example, the data can be analyzed using Weibull Parameters, i.e., the data can be ordered to yield a quantitative and statistical analysis of the failure rate. Hence, a precise estimate of the failure rate can be obtained by carrying out a precondition test according to the inventive concept.

Finally, embodiments of the inventive concept have been described herein in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiments described above but by the following claims.

What is claimed is:

1. A method of testing the reliability of a semiconductor package, comprising:
performing a baking test comprising baking the package to dry the package;
performing a moisture soaking test comprising moisturizing the dried package;
performing a reflow test on the moisturized package by heating air and circulating the heated air across a surface of the moisturized package, whereby the moisturized package is heated by convection; and
performing a 3-D imaging of the package comprising acquiring a three-dimensional image of the surface of the sample at a time after the reflow test has been initiated.

2. The reliability testing method according to claim 1, wherein the baking comprises storing the package in an ambient environment of at least 125° C. for at least 24 hours.

3. The reliability testing method according to claim 1, wherein the moisture soaking test comprises creating an ambient environment of a given temperature and relative humidity (RH), and exposing the package to the ambient environment for a predetermined period of time.

4. The reliability testing method according to claim 3, wherein the moisture soaking test comprises selectively exposing the package to a Level 1 ambient environment of 85° C./85% RH for 168 hours or less, a Level 2 ambient environment of 85° C./65% RH for 168 hours or less, and a Level 3 ambient environment of 30° C./60% RH for 192 hours or less.

5. The reliability testing method according to claim 1, wherein the reflow test comprises heating the air to a temperature of at least 260° C.

6. The reliability testing method according to claim 1, wherein a three-dimensional image of the surface of the sample is acquired at least once during the reflow test.

7. The reliability testing method according to claim 6, wherein the reflow test comprises increasing the temperature at which the air is heated by given increments and circulating the heated air of different temperatures across the surface of the package, and the performing of the 3-D imaging comprises acquiring a three-dimensional image of the surface of the package at each of several different temperatures to which the air is heated during the reflow test.

8. The reliability testing method according to claim 1, wherein the 3-D imaging comprises Moire interferometry.

9. The reliability testing method according to claim 8, wherein the 3-D imaging comprises:
directing light towards the surface of the package,
forming Moire interference fringes at the surface of the package from the light directed towards the package,
capturing an image of the interference fringes with a camera unit, and
processing an output of the camera unit.

10. The reliability testing method according to claim 9, wherein the baking test, the moisture soaking test, the reflow test and the 3-D imaging are carried out on each of a plurality of sample semiconductor packages, and further comprising analyzing the output of the camera unit to generate data of critical temperatures at which the sample semiconductor packages fail, and ordering the data as a Weibull Plot.

11. The reliability testing method according to claim 10, wherein, at the critical temperature, the 3-D image of the surface of the samples are acquired at each interval of 1° C.

12. The reliability testing method according to claim 1, wherein heating the air is performed by using IR heat source and circulating the heated air is performed by forcedly circulating the heated air around the package using a fan in a hot air convection oven.
